(19) United States
(12) Patent Application Publication
(10) Pub. No.: US 2014/0278736 A1
(43) Pub. Date: Sep. 18, 2014

(54) UTILIZING SHARED CUSTOMER DATA

(71) Applicant: BANK OF AMERICA CORPORATION, Charlotte, NC (US)

(72) Inventor: Hood Qaim-Maqami, Montclair, NJ (US)

(73) Assignee: BANK OF AMERICA CORPORATION, Charlotte, NC (US)

(21) Appl. No.: 13/796,273

(22) Filed: Mar. 12, 2013

(51) Int. Cl. G06Q 30/02

(52) U.S. Cl. CPC G06Q 30/0201
USPC 705/7.29

(57) ABSTRACT

Methods, systems, computer-readable media, and apparatuses for utilizing shared customer data are presented. In some embodiments, a computing device may detect a mobile device that is linked to a user account. Subsequently, the computing device may identify a user of the mobile device, based on shared customer data associated with the user account. The computing device also may retrieve customer information associated with the identified user from the shared customer data. Then, the computing device may provide the retrieved customer information to at least one merchant device. In one or more embodiments, the shared customer data may be collected by at least two different commercial entities, and the shared customer data may be available for use by the at least two different commercial entities.

### BACKGROUND

Aspects of the disclosure relate to computer hardware and software. In particular, one or more aspects of the disclosure generally relate to computer hardware and software for utilizing shared customer data.

Mobile devices, such as smart phones, tablet computers, and other types of mobile computing devices, are becoming more and more popular, and users of these devices are increasingly growing to demand and expect greater functionality and convenience from these devices.

Some current mobile devices now include features and functionalities that enable users to listen to music, read books, watch movies, play video games, communicate with users of other devices, shop online, make restaurant reservations, and check financial account balances. In addition, some newer mobile devices also provide location services (e.g., Global Positioning System (GPS) services and/or other positioning services), which may enable navigation and mapping functionalities to be provided. In some cases, in providing these functionalities, current mobile devices also may provide location-based advertising that may, for instance, be related to goods and services that are located near the current location of a particular mobile device.

Despite the existence of these functionalities in some existing systems, however, it might be difficult, if not impossible, to provide particular advertisements and/or other content to users who are actually interested in receiving such advertisements and/or other content. As a result, the user of a particular mobile device might receive advertisements and/or other content that are not appropriate for their interests, tastes, and/or needs, even if the advertisements and/or other content might be location-appropriate. This situation might not only result in user frustration and annoyance, but also may result in an inefficient and ineffective use of resources on the part of the commercial entities that may be creating and/or delivering the unwanted advertisements and/or other content.

### SUMMARY

Aspects of the disclosure provide various techniques that can enable mobile device users to receive advertisements, offers, and other content that is more appropriate and individualized. In addition, aspects of the disclosure also enable commercial entities to provide such advertisements, offers, and/or other content, along with more personalized and/or otherwise enhanced customer service to mobile device users in certain instances.

For example, in some embodiments discussed in greater detail below, a mobile device user who is visiting a merchant location (e.g., a grocery store, a department store, a banking center, and the like) can be detected and identified by a server or other computing device at the merchant location based on their mobile device, and this identification can enable more information about the mobile device user to be retrieved and utilized in providing more personalized customer service to the mobile device user. Additionally or alternatively, this identification can be utilized in providing targeted advertisements, offers, and/or other content to the mobile device user (e.g., via the mobile device or via other devices and/or entities at the merchant location).

Moreover, certain embodiments enable a mobile device user to be identified (and individualized customer service and/or targeted advertisements, offers, and/or other content to be provided), even in situations where the mobile device user is visiting a particular merchant location for the first time (e.g., where the user is shopping with a commercial entity that itself might not have additional information about the mobile device user). In particular, even though the commercial entity operating the merchant location might not have customer data about the particular mobile device user from previous interactions, the commercial entity (and/or one or more servers and/or other devices being used by the commercial entity) may utilize shared customer data about the particular mobile device user in order to identify the user and/or obtain more information about him or her. By utilizing shared customer data in these ways, the commercial entity may be able to avoid missing opportunities to engage with the mobile device user, who may be a potential new customer, and can instead offer him or her more individualized customer service, as well as targeted advertising, offers, and/or other content that the user might be interested in.

In some embodiments, this shared customer data may be collected and/or created by other commercial entities and may be maintained by a central server that is accessible to a number of different commercial entities, including, for instance, the commercial entity operating the merchant location in the example discussed above. In addition to accessing and using the shared customer data, the commercial entity also may contribute certain types and/or certain amounts of customer data to the shared customer data maintained by the central server. This contribution may, for instance, enable customers of the commercial entity to receive more individualized customer service and/or more relevant advertisements and offers when they are similarly visiting other commercial entities that have access to the shared customer data maintained by the central server.

By leveraging various aspects of these techniques and/or the other features and functionalities discussed in greater detail below, greater functionality and convenience may be provided to users of mobile devices, as these users may be able to receive advertisements, offers, and other content that is more appropriate and individualized, while also receiving more personalized customer service at certain merchant locations. In addition, various commercial entities may likewise be able to provide mobile device users with more appropriate and individualized advertisements, offers, and other content in more efficient and effective ways, while also improving and personalizing the level of customer service provided to these users in some instances.

Thus, in some embodiments discussed below, a computing device may detect a mobile device that is linked to a user account. Subsequently, the computing device may identify a user of the mobile device, based on shared customer data associated with the user account. The computing device also may retrieve customer information associated with the identified user from the shared customer data. Then, the computing device may provide the retrieved customer information to at least one merchant device.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of a system for utilizing shared customer data according to one or more illustrative aspects of the disclosure;

FIG. 3 illustrates an example of a data structure that may be used in storing and sharing customer data in some embodiments;

FIG. 4 illustrates an example of how shared customer data can be utilized to identify a user of a mobile device in some embodiments;

FIG. 5 illustrates an example of a user interface that may be displayed on a merchant device in some embodiments;

FIG. 6 illustrates an example of a user interface that may be displayed on an electronic sign in some embodiments; and

FIG. 7 illustrates a flowchart that depicts a method of utilizing shared customer data in one or more embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

As noted above, certain embodiments are discussed herein that relate to utilizing shared customer data. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail.

As introduced above, some aspects of the disclosure generally relate to utilizing shared customer data. In some embodiments, customer data that is shared among a number of different commercial entities may, for instance, be used by a particular commercial entity to provide differentiated service (e.g., more individualized customer service, targeted advertising and/or offers, and the like) to a mobile device user, even if he or she has not previously visited or been a customer of the particular commercial entity. Such a mobile device user may, for instance, be detected based on location information (e.g., geolocation information, presence information, and the like) obtained from their mobile device, and may further be identified by the commercial entity (and/or a server or other device being operated by the commercial entity) using the shared customer data. In the discussion below, various examples illustrating how shared customer data may be generated, collected, processed, and/or used will be described.

FIG. 2 illustrates an example of a system 200 for utilizing shared customer data according to one or more illustrative aspects of the disclosure. As seen in FIG. 2, system 200 may include a number of computing devices, as well as one or more networks, which may connect the various computing devices and enable these devices to communicate with each other. For example, system 200 may include a customer information server 205, a network 210, several retailer servers (e.g., server 215 and server 220), and several mobile devices (e.g., mobile device 225, mobile device 230, and mobile device 235). Each of these elements of system 200 is discussed in turn below.

In some embodiments, customer information server 205 may collect and store customer data from various sources. This customer data may include one or more customer information data structures (which are discussed in greater detail below with respect to FIG. 3), and the sources of this customer data may include multiple different commercial entities. These commercial entities may be of various different types, and may, for instance, include grocery stores, department stores, restaurants, banking centers and/or financial institutions, and other types of retailers and commercial entities. In one or more arrangements, customer information server 205 may index and/or otherwise organize the customer data received from these sources, which may enable the customer data to be searched more efficiently and effectively. Additionally, customer information server 205 may permit access to the customer data by authorized servers and/or devices that may, for instance, be used by the various commercial entities that contribute to the customer data stored by customer information server 205. In some instances, customer information server 205 also may encrypt some or all of the customer data in order to ensure and enhance the security of this information.

In some embodiments, network 210 may connect the customer information server 205 to different servers and devices located at various places and/or operated by various entities, such as at various retailers and/or various other commercial entities. For example, network 210 may connect the customer information server 205 to server 215 and server 220, which may each be located at a different retail store and operated by a different commercial entity. In some instances, network 210 may be a dedicated network (e.g., which is used only in connecting servers used by various commercial entities to the customer information server 205), while in other instances, network 210 may be part of another network, such as a wide-area network (e.g., the internet).

In some embodiments, the servers 215 and 220 may be deployed at different retail stores (or other locations) and may be operated by different commercial entities. Each of the servers 215 and 220 may, for instance, be configured to detect and/or otherwise recognize the presence of various user devices (e.g., mobile devices 225, 230, and 235) that may be present at the retail stores or other locations operated by the particular commercial entity that is operating and/or otherwise using the server. In some instances, such a server (e.g., server 215, server 220, and the like) may be deployed locally at a particular store or other merchant location operated by the commercial entity, while in other instances, such a server may be located at a central location for the commercial entity (e.g., at a local or regional office operated by the commercial entity).

In addition to detecting and/or otherwise recognizing the presence of a user device, such a server (e.g., server 215, server 220, and the like) also may communicate with the customer information server 205 after such a device has been detected in order to determine the identity of the user operating the user device, retrieve information about the user (e.g., from a database stored on the customer information server 205), and/or provide advertisements, offers, and/or other content to the user. As discussed below, the server (e.g., server 215, server 220, and the like) may, in some instances, store the advertisements, offers, and/or other content to be provided to various users (and, e.g., may select particular advertisements, offers, and/or other content to be displayed to a particular user based on the information retrieved from the customer information server 205). In other instances, the server may additionally or alternatively retrieve the advertisements, offers, and/or other content to be provided to various users from one or more other systems and/or servers (which may, e.g., by operated by the same commercial entity operating the server and/or by one or more other, different entities, such as an advertising partner or provider).

In some embodiments, the mobile devices (e.g., mobile devices 225, 230, and 235) may belong to different individual users who are visiting various merchant locations operated by various commercial entities. Additionally, the presence of each particular mobile device may be detected at the particular merchant location where the particular device is present by the commercial entity operating that merchant location (and/or a server operated by such a commercial entity, such as server 215 or server 220).

For instance, in the example depicted in FIG. 2, mobile devices 225 and 230 may be visiting a first merchant location operated by a first commercial entity, and the presence of these mobile devices may be detected by server 215, which may be deployed and used by the first commercial entity at the first merchant location. Similarly, mobile device 235 may be visiting a second merchant location operated by a second commercial entity, and the presence of this mobile device may be detected by server 220, which may be deployed and used by the second commercial entity at the second merchant location.

In some instances, a mobile device (e.g., mobile device 225, mobile device 230, mobile device 235, and the like) may include specialized software, such as an app, that enables the mobile device to be detected by a merchant server (e.g., server 215, server 220, and the like). Such software may, for instance, obtain position information from one or more location services provided by the mobile device (e.g., GPS services built into an operating system of the mobile device), and further may report this position information periodically to a central server (which may, e.g., be in communication with and/or be incorporated into the customer information server 205, one or more of the merchant servers 215 and 220, and/or another server or computing device). In other instances, this software may be configured to cause the mobile device (e.g., mobile device 225, mobile device 230, mobile device 235, and the like) to send a particular signal or message when position information (e.g., position information obtained from the location services provided by the mobile device) indicates that the device is located in a particular merchant location. In some instances, such a signal or message may be sent using Bluetooth, Near Field Communication (NFC), wireless LAN (WLAN), and/or other communication technologies.

In one particular example, a mobile device (e.g., mobile device 225, mobile device 230, mobile device 235, and the like) may include a mobile banking app that is provided by a financial institution, and the app may enable the user to view account balances, check account activity, and the like. When a user of the mobile device visits a particular merchant location, such as a banking center operated by the financial institution, the mobile banking app may, for instance, cause the mobile device to provide location information and/or send a signal or message to one or more other devices, which may cause a merchant server (e.g., server 215, server 220, and the like) to detect the presence of the mobile device at the location. This detection may, for instance, enable the user of the mobile device to be identified by the financial institution (and/or one or more employees in the banking center), which can then provide the user of the mobile device with more personalized service, as illustrated in some of the examples discussed in greater detail below.

FIG. 3 illustrates an example of a data structure 300 that may be used in storing and sharing customer data in some embodiments. In some embodiments, customer information data structure 300 may be stored by a customer information server, such as customer information server 205, and the customer information server may create and maintain such a data structure for each mobile device user for which the server stores customer data. In one or more embodiments, a customer information data structure 300 may be shared across commercial entities, so as to enable recognition of mobile devices (and mobile device users) at various merchant locations operated by different commercial entities. In addition, as seen in FIG. 3, each customer information data structure 300 may define, store, and/or otherwise include various types of information for a particular user (who may be a customer of at least one of the various commercial entities), and accordingly may include various fields that each may include different types of information.

For example, customer information data structure 300 may, in some embodiments, include a user account identifier field 305. In some instances, such a user account identifier field 305 may, for instance, include a unique username or other unique alphanumeric string that is assigned to (and/or can be used in identifying) a particular mobile device user and/or a particular user account.

In addition, customer information data structure 300 may, in some embodiments, include a linked devices field 310. In some instances, such a linked devices field 310 may, for instance, include information about the various devices (e.g., the one or more mobile devices) that are used by the particular mobile device user and/or the particular mobile device user account for which the data structure 300 is created and/or maintained. This information may, for instance, include information that can be used in recognizing the user's various devices. For example, linked devices field 310 may include one or more media access control (MAC) addresses that correspond to the various network interfaces included in the user's device(s), one or more serial numbers assigned to and/or otherwise associated with the user's device(s), and/or other unique identifiers that may correspond to the user's device(s).

In some embodiments, customer information data structure 300 also may include a customer name field 315 and a customer group field 320. In some instances, customer name field 315 may include the user's full name and/or one or more nicknames that might be preferred or used by the user. Additionally, customer group field 320 may, for instance, include a grouping or classification associated with the user. Such a grouping or classification may, for example, indicate whether the user has a particular rewards account or a particular status level with one or more commercial entities, what type of accounts the user might have with one or more commercial entities (e.g., what type(s) of accounts the user has with a financial institution), and/or other information that might be used in classifying and/or grouping the user with other, different users.

In some embodiments, customer information data structure 300 also may include an additional customer information field 325. In some instances, such an additional customer information field 325 may include other information about the particular user and/or the particular user account. For example, additional customer information field 325 may include information specifying the user's age, birthday, gender, city and/or state of residence, interests and/or hobbies, occupation, household income, and/or the like. In some instances, additional customer information field 325 also may include one or more pictures of the user (which may, e.g., be used in recognizing the user when he or she is at a particular merchant location). Additionally or alternatively, additional customer information field 325 may include presence information for the user (and/or the user's linked devices) that may indicate, for example, the current location(s) of each of the user's linked device(s), the merchant location(s) that the user has previously visited, the date(s) and/or time(s) at which such previous visit(s) occurred, the one or more commercial entities that have created and/or modified information about the user in the particular data structure 300, and/or other information. In some instances, the types and/or amount of information stored in additional customer information field 325 (and/or the entire customer information data structure 300) may vary for each individual user and may depend on the individual user's preferences. For instance, some users may opt-in to participate in these customer data sharing services to varying degrees, while other users might opt-out of these services entirely (and no customer data may be stored or maintained for these other users accordingly).

FIG. 4 illustrates an example of how shared customer data can be utilized to identify a user of a mobile device in some embodiments. In particular, as seen in FIG. 4, a store premises 400 may be operated by a particular commercial entity, and the store premises 400 may be visited by a mobile device user who is carrying and/or using a mobile device 405.

Upon entering the store premises 400, the presence of mobile device 405 may be detected and/or otherwise recognized by a merchant server at the premises 400, such as merchant server 410. Merchant server 410 may, for instance, implement one or more aspects of server 215 and/or server 220 (as discussed above with respect to FIG. 2). Based upon detecting the presence of the mobile device, merchant server 410 may, for example, access information stored in a customer information server (e.g., customer information server 205) in order to identify the mobile device 405 and/or the user thereof. For example, by cross-referencing information obtained from mobile device 405, such as a detected, recognized, and/or otherwise obtained device identifier corresponding to mobile device 405, with information about various devices included in various data structures stored by the customer information server (e.g., linked device information 310 stored in various customer information data structures 300 stored and/or maintained by customer information server 205), the merchant server 410 may be able to identify a particular customer information data structure that matches the detected mobile device 405. Based upon identifying such a matching data structure, server 410 may subsequently retrieve the matching data structure from the customer information server (e.g., customer information server 205), and the retrieved data structure may include various information about the user of the mobile device 405 that can then be used by server 410 (and/or the commercial entity operating the server 410).

In some instances, after retrieving the data structure that includes information about the user of the mobile device 405, server 410 may provide information about the user of the mobile device 405 to various merchant devices located at the store premises 400. For example, server 410 may provide a greeter tablet with the user's name (and/or other information, such as the user's picture, age, classification or grouping, and/or the like), which may enable a person who is operating the greeter tablet 415 (e.g., a store employee) to personally welcome the user of mobile device 405 to the store premises 400 and/or provide the user with enhanced and/or otherwise differentiated customer service (e.g., by directing the user to certain areas of the store where particular goods, services, and/or deals are available that the user might be interested in; by directing the user to a particular sale, area, or event that is reserved for certain customers; by providing other recommendations to the user; and/or the like). In some instances, server 410 may automatically determine various recommendations to be provided to the user of mobile device 405, and further may cause these recommendations to be displayed on greeter tablet 415. This may, for example, enable a store employee who is operating the greeter tablet 415 to more easily welcome and/or direct the user of mobile device 405.

In some instances, server 410 may additionally or alternatively cause information to be displayed and/or updated on a dynamic display sign 420 at the store premises 400. For example, server 410 may cause the dynamic display sign 420 to display a welcome message that welcomes the user of mobile device 405 to the store premises 400. As another example, server 410 may cause the dynamic display sign 420 to display one or more advertisements, offers, and/or other content which may be individualized for the user of mobile device 405 and/or which may direct the user to a particular area of store premises 400. In some instances, these advertisements, offers, and/or other content may be selected by the merchant server 410 (e.g., from a library of available advertisements, offers, and/or other content) based on the identity of the user of mobile device 405 (e.g., based on information about the user retrieved from the customer information server). In this way, the advertisements, offers, and/or other content that server 410 causes to be displayed on the dynamic display sign 420 may be targeted to and/or more appropriate for the user of mobile device 405.

Moreover, because the customer information maintained by the customer information server (e.g., customer information server 205) may be shared among different commercial entities, the user of mobile device 405 may receive such a personal welcome and/or individualized advertisements, offers, and/or other content (e.g., as in the examples above), even if the user has not previously been a customer of the commercial entity operating the store premises 400. For example, if the user of mobile device 405 has previously been a customer of another commercial entity (e.g., by shopping with, registering with, visiting, and/or otherwise providing information to this other commercial entity) that contributes information to the customer information server (e.g., customer information server 205), then this information can be used in identifying (and subsequently welcoming and/or providing individualized advertisements, offers, and/or other content to) the user during his or her visit to premises 400, even though the premises 400 may be operated by a different commercial entity than the one(s) that the user has previously been a customer of. Thus, the service level provided to the user at the store premises 400 may be enhanced, as the commercial entity operating store premises 400 may be able to obtain and use additional information about the user to better cater to the user's individual needs, tastes, interests, and/or the like.

In the examples discussed above, several illustrations of how a merchant server (e.g., server 410) may cause information to be provided to various merchant devices (e.g., greeter tablet 415 and dynamic display sign 420) at a merchant location operated by a commercial entity were provided. Several examples of the user interfaces that might be provided via these devices are discussed below with respect to FIGS. 5 and 6.

FIG. 5 illustrates an example of a user interface 500 that may be displayed on a merchant device in some embodiments. In particular, in one or more embodiments, user interface 500 may be displayed on a tablet computer (e.g., greeter tablet 415) or on another computing device operated by an employee of a commercial entity. In addition, user interface 500 may include various information about a mobile device user who has been detected and/or recognized at a location operated by the commercial entity (e.g., based on the mobile device being used and/or shared customer data obtained from a customer information server, as in the examples discussed above).

For example, user interface 500 may include a picture 505 of the mobile device user, a name 510 of the mobile device user, a classification 515 of the mobile device user (e.g., indicating a rewards level, an account type, and/or the like), and/or other information 520 associated with the mobile device user (e.g., indicating the last time that the user visited the particular merchant location; indicating certain departments, areas, or events that the user might be interested in; and/or the like). Additionally or alternatively, user interface 500 may include other information, such as one or more recommendations provided by a merchant server (e.g., server 410) and/or one or more advertisements, offers, and/or other content that might be selected for the user (e.g., by the server) based on the customer data obtained for the user. As discussed above, any and/or all of this customer data may, for instance, be obtained by a local server (e.g., server 410) or other device at the location where the greeter tablet (e.g., greeter tablet 415) is being used. In addition, the information displayed in user interface 500 may enable a user of the greeter tablet (e.g., a store employee operating greeter tablet 415) to welcome the user to the merchant location and/or provide the user with a more individualized customer service.

FIG. 6 illustrates an example of a user interface 600 that may be displayed on an electronic sign in some embodiments. In particular, in one or more embodiments, user interface 600 may be displayed on an electronic sign that is located in a merchant location (e.g., on dynamic display sign 420) or on another computing device that is located at the merchant location. In addition, user interface 600 may include information that is selected and caused to be displayed to a mobile device user who has been detected and/or recognized at the merchant location (e.g., based on the presence of his or her mobile device and/or based on shared customer data obtained from a customer information server, as in the examples discussed above).

For example, user interface 600 may include a welcome message 605 that may, for instance, welcome the user to the particular location. Additionally or alternatively, user interface 600 may include other information 610 that may, for instance, include advertisements, offers, and/or other content that have been individually selected for the user (e.g., by a merchant server at the merchant location, such as server 410 at store premises 400). In one or more arrangements, the information that is displayed in user interface 600 may, for example, be used to welcome the mobile device user to the merchant location and/or provide him or her with a more customized and individualized experience while he or she is visiting the merchant location (e.g., store premises 400), since the content and/or other information included in the user interface may be selected for the user based on the customer data that has been obtained for the user (e.g., shared customer data retrieved from a customer information server, as in the examples discussed above).

Having discussed various examples in which shared customer data may be utilized, several examples of the processing that may be performed (e.g., by a server deployed at a merchant location, such as server 215, server 220, server 410, and/or the like) will now be discussed with respect to FIG. 7.

FIG. 7 illustrates a flowchart that depicts a method of utilizing shared customer data in one or more embodiments. In some embodiments, the example method illustrated in FIG. 7 may be performed by a computing device, such as a computer server which may, for instance, implement one or more aspects of computing device 101. As indicated above, the computing device that may execute this method may, in some instances, be a server deployed at a merchant location, such as server 215, server 220, server 410, and/or the like. In other embodiments, the example method illustrated in FIG. 7 may be embodied in computer-executable instructions that may, for instance, be stored in a computer-readable medium, such as a memory.

As seen in FIG. 7, the method may begin in step 705, in which a computing device (e.g., a merchant server, such as server 215, server 220, server 410, and/or the like) may detect a mobile device. Such a mobile device may, for instance, be detected by the computing device at a merchant location at which the computing device (e.g., a merchant server, such as server 215, server 220, server 410, and/or the like) is also deployed.

In some instances, the mobile device may be detected based on geolocation data obtained from the mobile device. For example, the mobile device (e.g., user mobile device 405 of the examples discussed above) may report and/or otherwise provide location information and/or geolocation information to the computing device executing the method (e.g., the merchant server) and/or to a customer information server (e.g., customer information server 205). Based on receiving this information (or obtaining this information from the customer information server), the computing device executing the method (e.g., the merchant server) may, for instance, detect the mobile device by determining that the mobile device is located at the merchant location.

In other instances, the mobile device may be detected based on receiving a message from a software application that is being executed on the mobile device. For example, the mobile device may be detected by the merchant server based on the merchant server receiving a message from a mobile banking application that is being executed (or is configured to be executed) on the mobile device. In these instances, the software application (e.g., the mobile banking application) may determine, based on geolocation data (e.g., obtained from location services provided by the mobile device and/or monitored by the software application), that the mobile device is located at a merchant location (e.g., the store premises 400). Based on this determination, the software application (e.g., the mobile banking application) may cause the mobile device to send a message and/or a signal that can be detected by the merchant server which is executing the method. Although a mobile banking application is discussed in some examples here, any other kind of software application or “app” may likewise be used to provide similar functionality in additional and/or alternative embodiments.

Thus, in some instances where the mobile device is executing (or configured to execute) a mobile banking application provided by a financial institution, the mobile device may be detected by the computing device executing the method (e.g., the merchant server), based on geolocation data (e.g., provided and/or processed by the mobile banking application), during a visit to a banking center operated by the financial institution. In other instances, the mobile device may be similarly detected during a visit to another merchant location, and such detection may likewise be based on information obtained from and/or provided by a software application that is being executed by (or that is configured to be executed by) the mobile device.

After detecting the mobile device in step 705, the computing device (e.g., the merchant server, such as server 215, server 220, server 410, and/or the like) may, in step 710, identify the user of the detected mobile device. In one or more embodiments, the computing device may identify the user of the detected mobile device based on shared customer data. For example, in identifying the user of the detected mobile device, the computing device (e.g., the merchant server) may use information obtained from the mobile device (e.g., a unique identifier associated with the mobile device, such as one or more MAC addresses used by the one or more network interfaces included in the mobile device) to look up information about the mobile device (and the user thereof) that may be stored on a customer information server (e.g., customer information server 205). This look-up operation may, for instance, enable the computing device to identify the user of the detected mobile device (e.g., by locating, identifying, and/or selecting records that include shared customer data for the user, such as a customer information data structure corresponding to the user, as in the examples discussed above).

As illustrated in the examples discussed above, the shared customer data that may be used in identifying the user of the mobile device may, in some instances, be collected by a number of different commercial entities and/or may be available for use by a number of different commercial entities. Additionally, in some instances, the computing device executing the method (e.g., the merchant server, such as server 410) may be operated by a first commercial entity, and the user of the mobile device may be identified based on customer data that was originally collected (and/or provided to a customer information server, such as customer information server 205) by a second commercial entity different from the first commercial entity. For example, the user of the mobile device may be visiting a department store where he or she has not previously been a customer; however, the user may be identified and/or greeted by an employee of the department store (who may, e.g., be using a greeter tablet, such as greeter tablet 415) based on shared customer data for the user of the mobile device that was previously collected and/or created for the user by a financial institution of which the user is (or has previously been) a customer. In this way, a person who might not be a previous customer of a particular commercial entity might nevertheless be able to receive enhanced and/or otherwise differentiated service if they are a customer of certain other commercial entities, such as the financial institution in the example discussed above.

In some instances, a particular mobile device might be linked to two or more user accounts. For example, such a mobile device (e.g., a smart phone, a tablet computer, and/or the like) can be used by two or more users, who each might have their own user account. In these instances, in identifying the user of the mobile device, the computing device executing the method (e.g., the merchant server) may determine that the detected mobile device is linked to two or more user accounts (e.g., based on records maintained by and/or obtained from the customer information server, such as customer information server 205). Based on this determination, the computing device (e.g., the merchant server) may cause the mobile device to prompt the user to select a particular user account to be used. In some instances, this may cause the mobile device to prompt the user to select, log into, and/or otherwise authenticate with a particular user account provided by the mobile device. Subsequently, the computing device (e.g., the merchant server) may receive such a selection from the mobile device, and the selected account may be used by the computing device in identifying the current user of the mobile device (and, e.g., the other user accounts that can be provided by the mobile device may be disregarded by the computing device for purposes of identifying the user of the mobile device in this instance).

In step 715, the computing device (e.g., the merchant server, such as server 215, server 220, server 410, and/or the like) may retrieve customer information for the identified user. Such customer information may, for instance, be retrieved from a customer information server, such as customer information server 205. In addition, in retrieving the customer information for the identified user, the computing device (e.g., the merchant server) may download the records that may have been located, identified, and/or selected in step 710. In some instances, this may include downloading (e.g., from the customer information server) a customer information data structure (e.g., customer information data structure 300) corresponding to the user. As discussed above, such a data structure may include various types of information about the user, and any and/or all of this information may be used by the computing device (e.g., the merchant server) in providing a more personalized and/or otherwise enhanced customer experience to the user of the mobile device.

In step 720, the computing device (e.g., the merchant server, such as server 215, server 220, server 410, and/or the like) may provide customer information for the identified user to one or more merchant devices. In some instances, the customer information provided to the one or more merchant devices may include some or all of the customer information retrieved in step 715, while in other instances, the customer information provided to the one or more merchant devices may include additional and/or alternative information, such as information selected and/or generated by the computing device (e.g., the merchant server) based on the customer information retrieved in step 715.

For example, in step 720, the computing device (e.g., the merchant server) may provide retrieved customer information (such as the user's name, the user's picture, and/or the like) and/or other information (e.g., one or more advertisements, offers, and/or other content selected and/or generated by the merchant server based on the retrieved customer information) to a greeter tablet (e.g., greeter tablet 415), which may cause the greeter tablet to display this information (e.g., via a user interface, such as user interface 500). As another example, in step 720, the computing device (e.g., the merchant server) may provide retrieved customer information (such as the user's name) and/or other information (e.g., one or more advertisements, offers, and/or other content selected and/or generated by the merchant server based on the retrieved customer information) to a display sign (e.g., dynamic display sign 420), which may cause the display sign to display this information (e.g., via a user interface, such as user interface 600). In this way, such a display sign may be dynamically updated (e.g., by the merchant server) to display content that is selected based on the identity of the user of the mobile device. In additional and/or alternative embodiments, similar information may likewise be provided to other merchant devices, such as point-of-sale terminals and/or other payment devices, which may facilitate enhanced payment processes that utilize information retrieved from the customer information server (e.g., customer information server 205).

As illustrated in the examples discussed above, the customer information provided to the one or more merchant devices (e.g., in step 720 by the merchant server) may cause an entity operating the location being visited by the mobile device user to provide the user with a more enhanced and/or individualized level of service (e.g., as compared to a non-identified customer who may be visiting the same location but for which such shared customer data has not been defined, does not exist, and/or is otherwise unavailable). In this way, detection of the mobile device user based on the presence of the mobile device may enable the user to receive an enhanced and/or otherwise differentiated customer experience from the commercial entity. For example, in some instances, this detection may cause the entity operating the location to recognize the mobile device user as a preferred customer (which may, e.g., result in the mobile device user being directed to a particular area of the store, a special event, a shorter or faster line to purchase goods/services or speak with a customer service representative, and/or the like).

In step 725, the computing device (e.g., the merchant server, such as server 215, server 220, server 410, and/or the like) may update device presence information. For example, after providing information (which may include the retrieved customer information, as discussed above) to various merchant devices at the merchant location (e.g., store premises 400), the merchant server may, in step 725, update one or more records in a customer information server (e.g., customer information server 205) to reflect the detection of the mobile device at the merchant location. This updating may, for instance, include modifying information stored in a customer information data structure (e.g., data structure 300) that may be maintained by the customer information server for the mobile device user. In updating this information, the computing device (e.g., the merchant server) may, for instance, insert and/or modify information in such a data structure that indicates the current location of the user and/or the detected mobile device (e.g., as being at the merchant location), as well as information that reflects historical information about the mobile device user's visit to the merchant location (e.g., indicating that the visit occurred at a particular date and/or time, for a particular length of time, and/or the like) and/or other information. In some instances, such information about the current location of the user and/or the detected mobile device, as well as the historical information, may be used by the commercial entity operating the merchant location and/or one or more different commercial entities in providing more personalized and/or otherwise enhanced customer experiences to the user of the mobile device, which may, in some instances, include providing targeted advertising, offers, and/or other content, as illustrated in the examples above.

Subsequently, the method may end. Upon conclusion of the method illustrated in FIG. 7, the computing device (e.g., the merchant server) may, for example, enter a device detection loop in which the computing device may listen for, detect, and/or otherwise recognize the presence of other mobile devices and/or other mobile device users (e.g., by executing one or more steps similar to those discussed above).

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A computing device, comprising:
at least one processor; and
memory storing computer readable instructions that, when executed by the at least one processor, cause the computing device to:
detect a mobile device that is linked to a user account;
identify a user of the mobile device, based on shared customer data associated with the user account;
retrieve customer information associated with the identified user from the shared customer data; and
provide the retrieved customer information to at least one merchant device.

2. The computing device of claim 1, wherein detecting the mobile device is based on geolocation data obtained from the mobile device.

3. The computing device of claim 1, wherein detecting the mobile device is based on receiving at least one message from a mobile banking application that is configured to be executed on the mobile device.

4. The computing device of claim 3,
wherein the mobile device is detected during a visit to a banking center operated by a financial institution, and
wherein the mobile banking application is provided by the financial institution.

5. The computing device of claim 1, wherein the retrieved customer information provided to the at least one merchant device is configured to cause an entity operating a location being visited by the mobile device to provide the identified user with a first level of service different from a second level of service provided to a non-identified customer.

6. The computing device of claim 5, wherein the retrieved customer information provided to the at least one merchant device is configured to cause the entity to recognize the identified user as a preferred customer.

7. A method, comprising:
detecting, by a computing device, a mobile device that is linked to a user account;
identifying, by the computing device, a user of the mobile device, based on shared customer data associated with the user account;
retrieving, by the computing device, customer information associated with the identified user from the shared customer data; and
providing, by the computing device, the retrieved customer information to at least one merchant device.

8. The method of claim 7, wherein the shared customer data is collected by at least two different commercial entities.

9. The method of claim 7, wherein the shared customer data is available for use by at least two different commercial entities.

10. The method of claim 7,
wherein the at least one merchant device is operated by a first commercial entity being visited by the user of the mobile device, and
wherein the user of the mobile device is identified based on customer data collected by a second commercial entity different from the first commercial entity.

11. The method of claim 7, wherein the at least one merchant device is a tablet computer.

12. The method of claim 7, wherein the at least one merchant device is an electronic sign.

13. The method of claim 12, wherein providing the retrieved customer information to the at least one merchant device includes causing the electronic sign to be dynamically updated to display content that is selected based on the identity of the user of the mobile device.

14. The method of claim 7, wherein identifying the user of the mobile device includes:
determining that the mobile device is linked to at least two user accounts;
causing the mobile device to prompt the user to select a first user account of the at least two user accounts to be used for identification; and
receiving the selection from the mobile device.

15. The method of claim 7, wherein detecting the mobile device is based on geolocation data obtained from the mobile device.

16. The method of claim 7, wherein detecting the mobile device is based on receiving at least one message from a mobile banking application that is configured to be executed on the mobile device.

17. One or more non-transitory computer-readable media having computer-executable instructions stored thereon that, when executed by a computing device, cause the computing device to:
detect a mobile device that is linked to a user account;
identify a user of the mobile device, based on shared customer data associated with the user account;
retrieve customer information associated with the identified user from the shared customer data; and
provide the retrieved customer information to at least one merchant device.

18. The one or more non-transitory computer-readable media of claim 17, wherein detecting the mobile device is based on geolocation data obtained from the mobile device.

19. The one or more non-transitory computer-readable media of claim 17,
wherein the shared customer data is collected by at least two different commercial entities, and
wherein the shared customer data is available for use by the at least two different commercial entities.

20. The one or more non-transitory computer-readable media of claim 17,
wherein the at least one merchant device is operated by a first commercial entity being visited by the user of the mobile device, and
wherein the user of the mobile device is identified based on customer data collected by a second commercial entity different from the first commercial entity.
